(19) United States
(12) Patent Application Publication
(10) Pub. No.: US 2026/0066429 A1
(43) Pub. Date: Mar. 5, 2026

(54) BATTERY PACK

(71) Applicant: Kenta YASUDA, SHIZUOKA (JP)

(72) Inventor: Kenta YASUDA, SHIZUOKA (JP)

(21) Appl. No.: 19/100,531

(22) PCT Filed: Aug. 17, 2023
(86) PCT No.: PCT/JP2023/029728

§ 371 Date: Jan. 31, 2025

(30) Foreign Application Priority Data
Aug. 17, 2022 (JP) 2022-130138

(51) Int. Cl. H01M 50/244; H01M 50/204; H01M 50/256; H01M 50/296

(52) U.S. Cl. CPC H01M 50/244; H01M 50/204; H01M 50/256; H01M 50/296

(57) ABSTRACT

A battery pack including: a battery unit; a casing housing the battery unit and having a columnar shape; an external connection terminal exposed at an outer surface of the casing; and a support structure fixed to the casing. The support structure includes projects outward in a longitudinal direction of the casing from at least one end surface of the casing in the longitudinal direction, and includes a ring portion located at least one end of the battery pack in a longitudinal direction of the battery pack and oriented perpendicularly to the longitudinal direction of the casing.

### TECHNICAL FIELD

The present disclosure relates to a battery pack. This application claims priority to Japanese Patent Application No. 2022-130138, which was filed on Aug. 17, 2022, and is incorporated herein by reference in its entirety.

### BACKGROUND ART

A configuration for easily carrying battery packs has been studied. Patent Literature 1, for example, discloses a battery pack in which a pair of bracket members are disposed at both side surfaces of a storage battery body and handles are detachably attached to the brackets.

Patent Literature 2 discloses a battery unit in which side surfaces of a casing for housing a storage battery module have bolt holes to which carrying handles are detachably attached.

### CITATION LIST

### Patent Literatures

Patent Literature 1: Japanese U.S. Pat. No. 7,036,801
Patent Literature 2: Japanese Patent Application Publication No. 2019-109985

### SUMMARY OF INVENTION

### Technical Problem

Any of the battery packs of Patent Literatures 1 and 2 includes the detachable handles to ease movement and installation of the battery pack. Such a structure is useful for a case where the battery pack is light enough to be carried by hand (e.g., up to about 20 Kg). However, this structure cannot be considered sufficient for transporting battery packs that are too heavy to lift and carry.

It is therefore an object of the present disclosure to provide a battery pack that can be easily transported.

### SOLUTION TO PROBLEM

A battery pack according to the present disclosure includes: a battery unit; a casing housing the battery unit and having a columnar shape; an external connection terminal exposed at an outer surface of the casing; and a support structure fixed to the casing. The support structure projects outward in a longitudinal direction of the casing from at least one end surface of the casing in the longitudinal direction, and includes a ring portion located at least one end of the battery pack in a longitudinal direction of the battery pack and oriented perpendicularly to the longitudinal direction of the casing.

### ADVANTAGES OF INVENTION

The present disclosure can provide a battery pack that can be easily transported.

### BRIEF DESCRIPTION OF DRAWINGS

FIG. 1 A perspective view of a battery pack according to a first embodiment.

FIG. 2 A side view of the battery pack illustrated in FIG. 1.

FIG. 3 A plan view of a state when the battery pack illustrated in FIG. 1 is seen from an end surface thereof.

FIG. 4 An enlarged schematic view of a portion of the battery pack in FIG. 1 illustrating a state during transport.

FIG. 5 A perspective view of a battery pack according to a second embodiment.

FIG. 6 A side view of the battery pack illustrated in FIG. 5.

FIG. 7 A plan view of a state when the battery pack illustrated in FIG. 5 is seen from an end surface thereof.

FIG. 8 A schematic view illustrating a state where a battery pack according to the present disclosure is transported.

FIG. 9 A schematic view illustrating a state where the battery pack according to the present disclosure is stored and transported.

### DESCRIPTION OF EMBODIMENTS

### Summary of Embodiment

A battery pack according to the present disclosure includes: a battery unit, a casing housing the battery unit and having columnar shape; an external connection terminal exposed at an outer surface of the casing; and a support structure fixed to the casing. The support structure includes a ring portion located at least one end of the battery pack in a longitudinal direction of the battery pack and oriented perpendicular to the longitudinal direction of the casing.

Electrification is progressing across a wide range of fields including industrial vehicles, agricultural machinery, and construction machinery. Accordingly, larger-capacity batteries are needed and there has been a demand for batteries that are easy to charge. In particular, in industrial vehicles and agricultural machinery, for example, a large amount of electric power is required not only to move vehicles themselves but also to operate work machinery such as arms and rotors. Batteries intended for such applications are required to perform performance as storage batteries but also to be easily transported and stored and to have environmental resistance. On the other hand, batteries inevitably become heavy because of the nature thereof.

Under such circumstances, a configuration was studied to enable manual transport of even batteries that are too heavy to lift and carry. This led to the idea of transporting the batteries by rolling instead of lifting. Further considerations resulted in the concept of a battery pack including a columnar casing whose end portion is equipped with a ring-shaped support structure.

A battery pack according to the present disclosure includes a support structure fixed to a casing, and includes a ring portion located at least one end of the battery pack in the longitudinal direction and oriented perpendicular to the longitudinal direction of the casing. With this configuration, the battery pack is tilted to bring the ring portion into point contact with the floor or the ground and, in this state, the entire battery pack is rotated by using the shape of the ring portion, thereby moving the battery pack. Thus, it is possible to move the battery pack with a small force without lifting the battery pack. That is, a large-capacity, heavy, and large-size battery can be transported manually without using a mechanical transport device. In addition, the battery pack can be stored upright with the support structure positioned at the bottom. At this time, since the casing is separated from the floor surface or the ground by the support structure, the casing of the battery pack is not in direct contact with the floor or the ground. This prevents entering of moisture and pollutants into the casing. Even if flooding or similar troubles occur in the storage place, the battery housed in the casing is less likely to be affected, thus exhibiting excellent environmental resistance and safety.

The ring portion may have a rounded corner when the ring portion is seen from a side surface of the ring portion. Since the ring portion has the rounded corner, the battery pack can be easily tilted and brought into point contact with the floor or the ground, and can be transported with safety.

The external connection terminal may be located within a region surrounded by the support structure. In general, a battery pack includes an external connection terminal (connector) for supplying electricity to an external device and charging the battery pack. The external connection terminal often projects from the casing in consideration of easiness in handling. Thus, when a battery pack falls or collision occurs among battery packs, external connection terminals might be damaged. In this regard, the battery pack according to the present disclosure, since the external connection terminal is located within the region surrounded by the support structure, the support structure serves as a protector to protect the external connection terminal. Accordingly, the battery pack is more easily transported and stored and has safety.

The support structure may have no portion extending outward from an outer peripheral surface of the casing when the battery pack is seen from an end surface of the battery pack. This configuration enables the casings of the battery packs to be arranged closely. Since the support structure does not project from the casing in this case, it is possible to suppress an increase in volume occupied by the battery pack caused by the presence of the support structure. This configuration enables a plurality of battery packs to be arranged closely with high density, and the battery packs can be easily stored.

The support structure may project outward from each of both end surfaces of the casing in the longitudinal direction. The presence of the support structures at both end surfaces of the casing eases transport of the battery pack in a case where both ends of the battery pack are brought into contact with the floor or the ground. In addition, one of the support structures is brought into contact with the floor or the ground, and the other support structure is rotated while being supported by hand, thereby enabling more stable and easy transport of the battery pack.

The support structure may include the ring portion, and a plurality of struts connecting the ring portion to the casing. This configuration of the support structure can suppress an increase in weight caused by attaching the support structure. In addition, water or other substances are not accumulated on an end surface of the casing, and any moisture, dust, or dirt that adheres to the surface can be quickly removed.

The support structure may include the ring portion, and a cylindrical support wall connecting the ring portion to the casing, and the supporting wall may have a plurality of openings. This configuration of the support structure can support and transport even a heavy battery with stability. In addition, since the support wall has the openings, water or other substances are not accumulated on an end surface of the casing, and any moisture, dust, or dirt that adheres to the surface can be quickly removed.

### Specific Examples of Embodiment

Example of specific embodiments of a battery pack according to the present disclosure will be described with reference to the drawings. In the following drawings, the same or corresponding parts are denoted by the same reference numerals, and the description thereof will not be repeated.

### First Embodiment

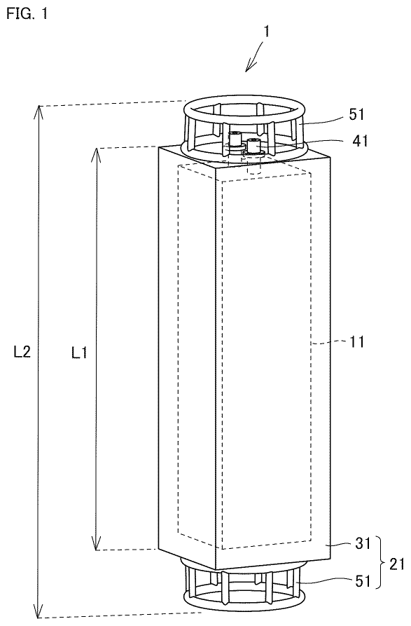

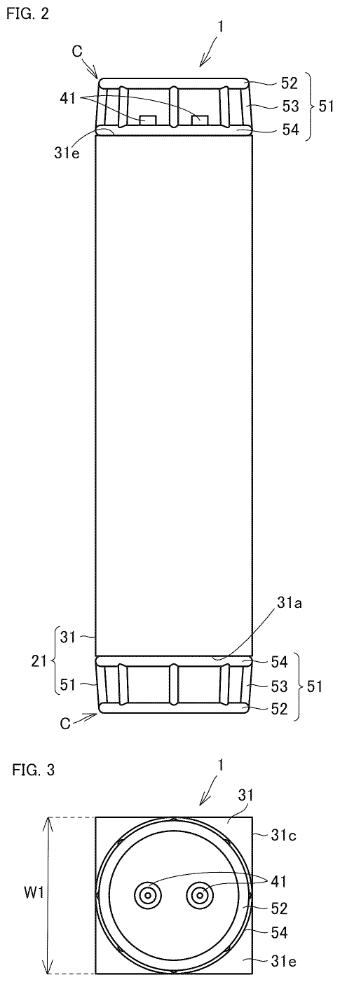

A configuration of a battery pack 1 as an example of an embodiment of a battery pack according to the present disclosure will be described with reference to FIGS. 1 through 3. FIG. 1 is a perspective view of the battery pack 1. FIG. 2 is a side view of the battery pack 1. FIG. 3 is a plan view of a state where the battery pack 1 is seen from an end surface thereof. It should be noted that all the drawings are schematic views, and components not directly related to the primary structure associated with the effects of the present disclosure are omitted in the drawings.

With reference to FIG. 1, the battery pack 1 includes a battery unit 11, a casing 31 housing the battery unit 11, an external connection terminal 41 exposed at the outer surface of the casing 31, and support structures 51 fixed to the casing 31. The casing 31 and the support structures 51 constitute a package 21 of the battery pack 1.

Dimensions of the battery pack 1 are not limited, and for example, a length L1 of the casing 31 in the longitudinal direction may be about 500 mm to about 1800 mm, typically about 800 mm to about 1400 mm. A length L2 as a sum of the length of the casing 31 and lengths of the support structures 51 disposed at both ends of the casing 31 may be about 700 mm to about 2000 mm, typically about 1000 mmm to about 1800 mm. With dimensions within this range, the battery pack can be tilted and brought into point contact with the floor or the ground, thus making it easy to roll the battery pack by hand.

The weight of the battery pack 1 is not particularly limited, and may be, for example, 5 Kg or more, typically 20 Kg or more. The upper limit of the weight is not particularly limited, either, and is, for example, 200 Kg or less. In particular, the battery pack according to the present disclosure enables manual transport of a battery that is too heavy to lift and carry by hand, without the use of mechanical equipment.

The casing 31 has a quadrilateral columnar shape whose cross section perpendicular to the longitudinal direction is approximately square. The shape of the casing 31, however, may be another shape not illustrated in FIG. 1, such as a prismatic or cylindrical shape. For example, the cross section of the casing 31 perpendicular to the longitudinal direction may be a rectangle other than an approximate square, a shape with some corners of a rectangle trimmed, a hexagon, an octagon, or other shapes. The cross section may be a rounded polygon with curved corners. It should be noted that the term “columnar” broadly refers to a three-dimensional shape formed by one or more side surfaces extending in the longitudinal direction and end surfaces extending to seal the ends of the side surfaces. The plurality of side surfaces do not necessarily need to have identical shapes. That is, depending on the shape of apparatus in which the battery pack is incorporated and the configurations of components of the battery pack, recesses or projections may be formed on side surfaces of a prism and/or end surfaces of the prism. In a case where the casing is cylindrical, the cross section of the casing perpendicular to the longitudinal direction may have any shape, such as a perfect circle, an ellipse, or a combination of circular arcs and straight lines. The battery pack according to the present disclosure includes ring portions at ends of the support structures fixed to the casing so that the battery pack can be easily transported by hand of a person, irrespective of the shape of the casing.

The battery unit 11 is housed in the casing 31. The battery unit 11 is not limited to a particular configuration, and generally includes a plurality of battery cells connected in series or in parallel and a wiring board connected to the battery cells through wires. An electronic circuit for controlling and managing operation of the battery cells is mounted on the wiring board. Examples of the battery cells include secondary batteries such as lithium ion batteries, nickel-metal hydride batteries, and nickel-cadmium batteries. The wiring board may be held by a board holder, and the board holder and the battery cell are fixed to each other. The battery unit 11 may include a plurality of combinations (battery modules) of the battery cells and the wiring boards. The casing 31 can house other devices such as a safety device, a controller, and a sensor, as well as the battery unit 11.

The battery unit 11 is connected to the external connection terminal 41 through wires. At least a portion of the external connection terminal 41 is exposed at the outer surface of the casing 31. The external connection terminal 41 includes a pair of terminals, that is, a positive (+) terminal and a negative (−) terminal. The external connection terminal 41 may, of course, include one or more output terminals and one or more input terminals, as well as the example illustrated in FIG. 1.

The battery pack 1 includes the support structure 51 at each end thereof in the longitudinal direction. The support structures 51 are fixed to the casing 31. Specifically, each of the support structures 51 projects outward in the longitudinal direction from the corresponding end surface of the casing 31 in the longitudinal direction. The support structures 51 may be non-detachably fixed to the casing 31 or may be detachably fixed to the casing 31.

The support structures 51 will now be described. With reference to FIGS. 1 and 2, each support structure 51 includes a ring portion 52, struts 53, and a base 54. The ring portion 52 is oriented such that the surface of the ring portion 52 including the circumference thereof intersects with the longitudinal direction of the casing 31. Specifically, the circumference (the surface including the circumference) of the ring portion 52 is oriented perpendicularly to the longitudinal direction of the casing 31. The battery pack 1 includes the ring portions 52 at both ends thereof in the longitudinal direction. The bases 54 are individually fixed to surfaces 31a and 31e of the casing 31 in the longitudinal direction. The ring portions 52 are separated from the bases 54 and oriented in parallel with the bases 54 (i.e., in parallel with the surfaces 31a and 31e). The base 54 and the ring portion 52 is connected to each other by the struts 53. Eight struts 53 are arranged at regular intervals in the circumferential direction of the ring portion 52. The number of the struts 53 is, of course, not limited, and can be about 4 to about 16 in accordance with required strength. The diameter of the ring portion 52 is slightly smaller than that of the base 54. This configuration is not essential, and the ring portion 52 and the base 54 may have the same diameter. No bases 54 may be used so that the struts 53 are directly fixed to the surfaces 31a and 31e.

The ring portion 52 is composed of a pipe-shaped or solid round rod-shaped member with a uniform thickness throughout the entire circumference, and has a circular cross section in the radial direction. Accordingly, when the ring portion 52 is seen from a side surface thereof (i.e., in the state of FIG. 2), an outer corner C is rounded. Since the corner C is rounded, when the battery pack 1 is tilted and brought in point contact with the floor or the ground, the battery pack exhibits excellent stability against the contact surface. In addition, since the battery pack 1 can be stably held at any angle, it is easy to handle the battery pack, regardless of the physique of an operator or other factors.

The support structure 51 is not necessarily a steel material, for example, and may be made of a hard resin or a resin composite material. The material for the support structure 51 is not particularly limited, and is selected as appropriate in consideration of the weight and required strength of the battery pack 1. Similarly, the casing 31 may be a steel material, for example, or may be made of a hard resin or a resin composite material. From the viewpoint of suppressing an increase in weight, the casing 1 and the support structure 51 constituting the package 21 of the battery pack 1 are preferably a hard resin or a combination of a hard resin and a steel material.

The external connection terminal 41 is disposed on the end surface 31e of the casing 31 and located within a region surrounded by the support structure 51. Although not shown, in the region surrounded by the support structure 51, connectors such as an input terminal and an output terminal, switches, indicators, a liquid crystal display, a handle, and other members are also preferably disposed, in addition to the external connection terminal 41. The external connection terminal 41 may be located only within the region surrounded by the support structure 51, and may be partially or entirely located on another region (e.g., side surface of the casing 31).

With reference to FIG. 3, the end surface 31e of the casing 31 has an approximately square shape. That is, a cross section (i.e., cross section of a region surrounded by the outer peripheral surface 31c) of the casing 31 perpendicular to the longitudinal direction is a substantially square. A width W1 of a side of the end surface 31e may be, for example, about 150 mm to about 800 mm, typically about 200 mm to about 500 mm. As illustrated in FIG. 3, when the battery pack 1 is seen from an end surface thereof, the support structure 51 does not include a portion extending outward of the outer peripheral surface 31c of the casing 31. The ring portion 52 has an annular shape of a perfect circle, and the outer diameter of the ring portion 52 is substantially equal to the length W1 of a side of the end surface 31e. As illustrated in FIG. 3, when the battery pack 1 is seen from the end surface, the outer circumference of the ring portion 52 is located inside the outer peripheral surface 31c of the casing 31, that is, the outer edge of the end surface 31e of the casing 31.

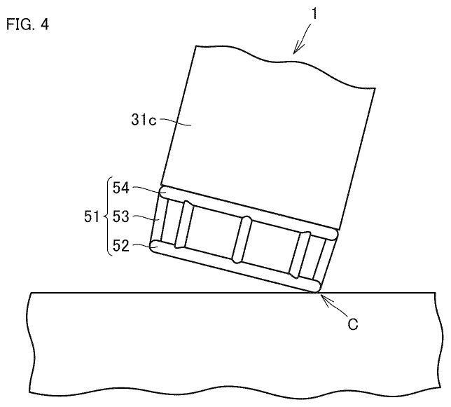

FIG. 4 is an enlarged schematic view of a portion of the battery pack in FIG. 1 illustrating a state during transport. The battery pack 1 can be transported in the same manner as transporting a drum barrel. With reference to FIG. 4, in transporting the battery pack 1, the battery pack 1 is tilted with respect to the contact surface such that the ring portion 52 is in point contact with the contact surface. In this state, an operator rotates the battery pack 1 along the ring portion 52 while supporting the battery pack 1, thereby moving the battery pack 1. Since the corner C of the ring portion 52 is rounded, the operator can stably hold the battery pack 1.

### Second Embodiment

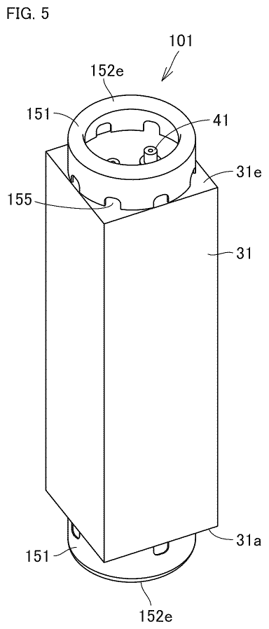

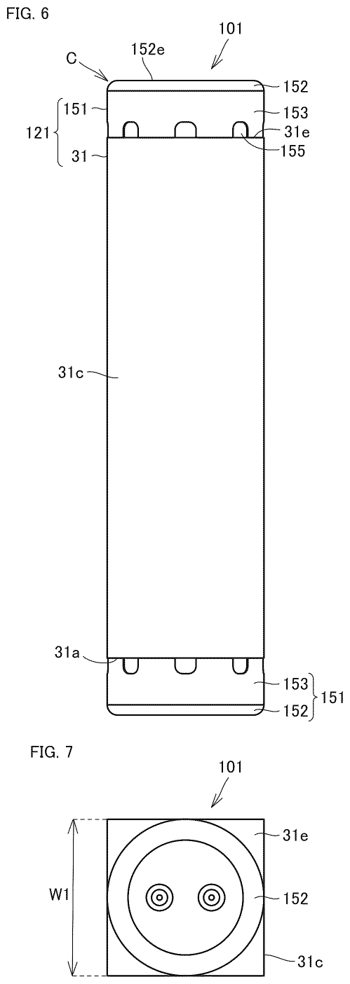

Next, a battery pack 101 as an example of an embodiment of a battery pack according to the present disclosure will be described. FIG. 5 is a perspective view of the battery pack 101. FIG. 6 is a side view of the battery pack 101. FIG. 7 is a plan view when the battery pack 101 is seen from an end surface thereof. A casing 31 of the battery pack 101 is similar to that of the battery pack 1, and denoted by the same reference numeral and will not be described again.

With reference to FIG. 5, the battery pack 101 is different from the battery pack 1 in the configuration of support structures 151. The support structures 151 project outward in the longitudinal direction respectively from both end surfaces 31a and 31e of the casing 31. The entire support structures 151 are thick cylindrical members each formed by bending a plate, and have rounded end portions 152e.

With reference to FIG. 6, in each support structure 151, a ring portion 152 and a support wall 153 are continuous and integrated. The ring portion 152 has a curved outer corner C. The support wall 153 is a cylindrical wall surface, and has a plurality of openings 155 arranged at regular intervals in the circumferential direction of the support wall 153. Although the support structure 151 includes eight openings 155, but the number of openings is not particularly limited. The openings 155 are in contact with the surfaces 31a and 31e of the casing 31.

With reference to FIGS. 6 and 7, the casing 31 and the support structures 151 constitute a package 121 of the battery pack 101. The support structures 151 do not project outward from an outer peripheral surface 31c of the casing 31. That is, the outer diameter of the ring portion 152 is substantially equal to a length W1 of a side of the end surface 31e of the casing 31. The end portion 152e of the ring portion 152 is parallel to the surfaces 31a and 31e and perpendicular to the longitudinal direction of the casing 31. That is, the circumferential direction of the ring portion 152 is perpendicular to the longitudinal direction of the casing 31. Thus, the battery pack 101 can be stored upright by bringing the ring portion 152 into contact with the floor or the ground. The battery pack 101 can also be rotated to be easily transported by tilting the battery pack 101 and bringing the ring portion 152 into point contact with the floor or the ground.

### Variations

The battery pack according to the present disclosure can have various aspects other than the specific examples described above. For example, the support structure may be disposed only at one end of the casing. The casing and the support structure may be continuous and integrated. The ring portion of the support structure is not limited to a seamless annular shape, and may form a ring shape as a whole. That is, the ring portion may also have an annular shape that is partially cut. Dimensions of the ring portion of the support structure may be determined in consideration of strength and easiness in transport, the outer diameter of the ring portion may be smaller than that of a side of the casing or may be larger than that of a side of the casing. As long as advantages of the present disclosure are obtained, the ring portion is not limited to a perfect circle, and may be an ellipse, a rounded polygon (octagon, decagon, etc.) in accordance with the shape of the casing.

### Aspects of Application

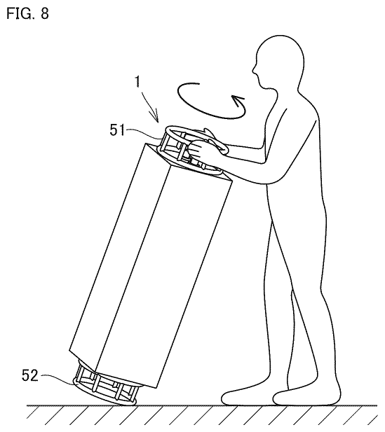

FIG. 8 is a schematic view illustrating a state where the battery pack 1 is transported. A procedure of transporting the battery pack 1 will be described below. First, the battery pack 1 is taken out from a storage place or apparatus (e.g., work vehicle) in which the battery pack is incorporated, and the battery pack 1 is placed upright with one of the ring portions 52 located at the bottom. Next, an operator places their hands on the upper support structure 51 of the battery pack 1, and holds the battery pack 1 with the battery pack 1 tilted and in point contact with the floor or the ground, as illustrated in FIG. 8. Then, the operator rotates the battery pack 1 along the circumference of the ring portion 52 to thereby move the battery pack 1. With this transport method, even a battery pack exceeding 100 Kg, for example, can be moved manually without a transport device.

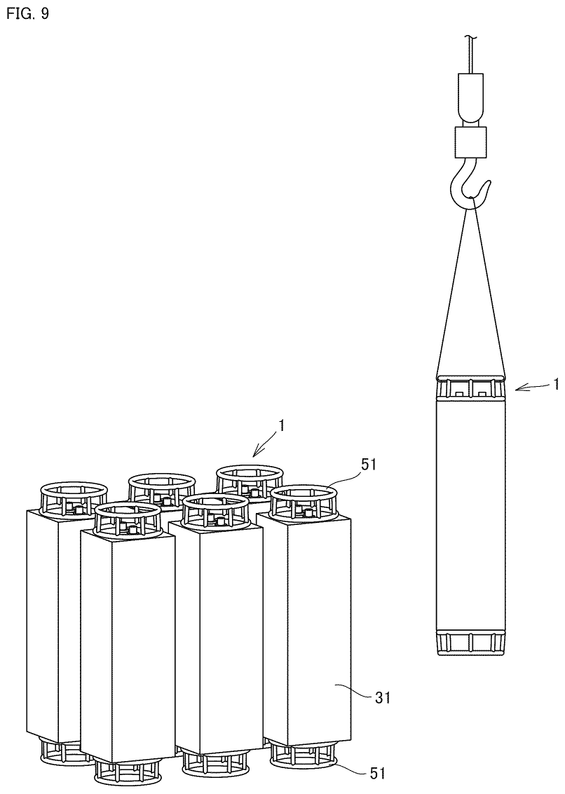

FIG. 9 is a schematic view illustrating a state where the battery pack 1 is stored and transported. With reference to FIG. 9, a plurality of battery packs 1 can be stored upright and arranged closely together in multiple rows, and thus, can be easily managed. In addition, since the support structure 51 is disposed at the lower surface, the casing 31 is not in direct contact with the floor of the storage place or the ground. Further, the battery pack 1 can also be easily moved using a hoist crane or heavy machinery by attaching a rope or the like to the upper support structure 51.

Application of the battery pack according to the present disclosure is not particularly limited, and is preferably applicable to an exchangeable battery in work vehicles such as electric industrial vehicles, electric agricultural machinery, and electric construction machinery, an exchangeable battery for various work machines for industrial, medical, or general household use, or a general-purpose power supply (mobile battery).

It should be understood that the embodiments disclosed here are illustrative and non-restrictive in every respect. The scope of the present disclosure is defined by the claims, rather than the description above, and is intended to include any modifications within the scope and meaning equivalent to the claims.

### DESCRIPTION OF REFERENCE NUMERALS

1, 101 battery pack, 11 battery unit, 31 casing, 41 external connection terminal, 51, 151 support structure, 52, 152 ring portion, 53 strut, 54 base, 153 support wall, 155 opening.

1. A battery pack comprising:
a battery unit;
a casing housing the battery unit and having a columnar shape;
an external connection terminal exposed at an outer surface of the casing; and
a support structure fixed to the casing, wherein
the support structure
projects outward in a longitudinal direction of the casing from at least one end surface of the casing in the longitudinal direction, and
includes a ring portion located at least one end of the battery pack in a longitudinal direction of the battery pack and oriented perpendicularly to the longitudinal direction of the casing.

2. The battery pack according to claim 1, wherein the ring portion has a rounded corner when the ring portion is seen from a side surface of the ring portion.

3. The battery pack according to claim 1, wherein the ring portion has no portion extending outward from an outer peripheral surface of the casing when the battery pack is seen from an end surface of the battery pack.

4. The battery pack according to claim 1, wherein the external connection terminal is located within a region surrounded by the support structure.

5. The battery pack according to claim 1, wherein the casing has a quadrilateral columnar shape whose cross section perpendicular to the longitudinal direction is rectangular.

6. The battery pack according to claim 1, wherein
the support structure includes
the ring portion, and
a plurality of struts connecting the ring portion to the casing.

7. The battery pack according to claim claims 1, wherein
the support structure includes
the ring portion, and
a cylindrical support wall connecting the ring portion to the casing, and the support wall has a plurality of openings.
